(19) United States
(12) Patent Application Publication
(10) Pub. No.: US 2005/0144336 A1
(43) Pub. Date: Jun. 30, 2005

(54) Method and apparatus for data sharing

(76) Inventor: Kuo-Chao Lin, Hsinchu (TW)

Correspondence Address: BIRCH, STEWART, KOLASCH & BIRCH, LLP;Joe McKinney Muncy, Suite 100 East, 8110 Gatehouse Rd, Falls Church, VA, 22040-0747, US

(21) Appl. No.: 10/888,999

(22) Filed: Jul. 13, 2004

(30) Foreign Application Priority Data
Dec. 31, 2003 (TW) 092137644

(51) Int. Cl. G06F 12/00

(52) U.S. Cl. 710/22; 711/115

(57) ABSTRACT

A method and an apparatus for directly copying data between multiple memory cards. In the invention data is transferred between various memory cards of different format without occupying memory or a system bus by means of the internal direct memory access (DMA) controller in cooperation with software drivers.

### BACKGROUND

The present invention relates to a method and an apparatus for directly copying data between multiple memory cards, and in particular, a method for transferring data between various memory cards of different format without occupying memory or system buses by means of the internal direct memory access (DMA) controller in cooperation with software drivers, and an apparatus implementing the method.

Flash memory cards are convenient and portable due to their minimal size. Specifications between various memory cards, however, are incompatible, such as Memory-Stick (MS), Safe-Digital (SD), Smart-Media(SM), xD-Picture (XD) and the like. Consequently multi-card readers are becoming popular due to the demand for convenience. Conventional multi-card readers typically employ the Universal Serial Bus (USB), Low Pin Count (LPC), or Peripheral Component Interconnect (PCI) interface for data transfer.

In a conventional multi-card reader using the PCI interface, in order to copy data from a first card reader to a second card reader, the following components are occupied in sequence when reading data: the first memory card, DMA (Direct Memory Access) controller, PCI bus, south bridge, north bridge, and main memory. Similarly, when data is to be written from main memory to the second memory card, the following components are occupied in sequence, main memory, north bridge, south bridge, PCI bus, DMA controller, and finally the second memory card. Therefore the resources of the PCI bus are occupied twice, the central processing unit is interrupted twice, and the main memory is accessed twice.

As shown in FIG. 1, data in conventional external PCI devices 20, 21, and 22, whether for reading or writing, inevitably occupy system bus 23, north and south bridge 25, and main memory 24.

FIG. 2 shows a process of copying from memory card 16 to memory card 17 when the multi-card reader 27 inserted in the system bus 14. First, a copy command is delivered to card-reader drivers 8 and 9 from an operating system 10. The card-reader driver 8 corresponds to a card reader 3 while the card-reader driver 9 corresponds to a card reader 4. The DMA controller 1 and card readers 3˜4 are then initialized by the copy command which is thereafter received by a bus slave 7 inside the bus controller 13. The operating system 10 is then acknowledged by an interrupt 11 sent through a bus master 6, indicating initiation of a copying process.

After initialization is complete, data is transferred from card reader 3 to DMA controller 1, via system bus 14 controlled by the bus master 6, through the north and south bridge 25, and are finally written to the main memory 24.

Thereafter, data is read and transferred again, from the main memory 24, through north and south bridge 25, via system bus 14 controlled by bus master 6, to the DMA controller 1. The copying process is complete when data is written to the memory card 17 in card reader 4 through the DMA controller 1. When complete, an interrupt is simultaneously sent to the operating system 10 by bus master 6 to inform the system that the copying process is complete.

In the conventional method, data is read and written through direct memory access technology, and components are occupied in the following order. Memory card 16, card reader 3, DMA controller 1, bus master 6, system bus 14, north and south bridge 25, main memory 24, north and south bridge 25, system bus 14, bus master 6, DMA controller 1, card reader 4, memory card 17, for a total of 13 steps. The system is therefore interrupted twice. The conventional method places a heavy burden on the PCI bus, wasting bandwidth, and causing a transfer bottleneck between the main memory and the PCI bus.

### SUMMARY

An object of the present invention is to provide a method for copying between multiple memory cards without occupying the system bus and main memory.

The method provided by the present invention is called hidden DMA (Direct Memory Access) transfer, and a multi-card reader implementing the method is also provided.

The multi-card reader comprises a multi-card interface, a bus controller, a DMA controller. The multi-card interface further comprises multiple slots of various formats, accepting memory cards of different specifications. The bus controller comprises a bus master and a bus slave, each of which controls certain operations. The DMA controller, a major processor for data transfer, under control of the system drivers, handles all data flow between the card readers and the system.

In a case where data is to be copied from a first memory card to a second memory card, the following steps are required. First, a copy command sent from a system through a system bus is received. Data is then read from a first memory card through a first card reader after receiving the copy command. Finally data is written to a second memory card through a second card reader directly without occupying the system bus. Therefore the memory and system bus are not occupied by the data copying process, and only one interrupt notifying the system that the copying process has been initiated is delivered. An internal flag is triggered when the system acknowledges the interrupt, and the copying process is determined to be complete when the value of the flag is a pre-determined value.

Thus by means of the method of hidden DMA transfer according to the present invention, only the following components are occupied in order. Memory card 16, card reader 3, DMA controller, card reader 4, and memory card 17, for a total of 5 steps, and only one system interrupt is required. In comparison to the 13 steps and two interrupts of the conventional system, the method of the present invention is faster and more efficient.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a flowchart showing data transfer according to the related art;

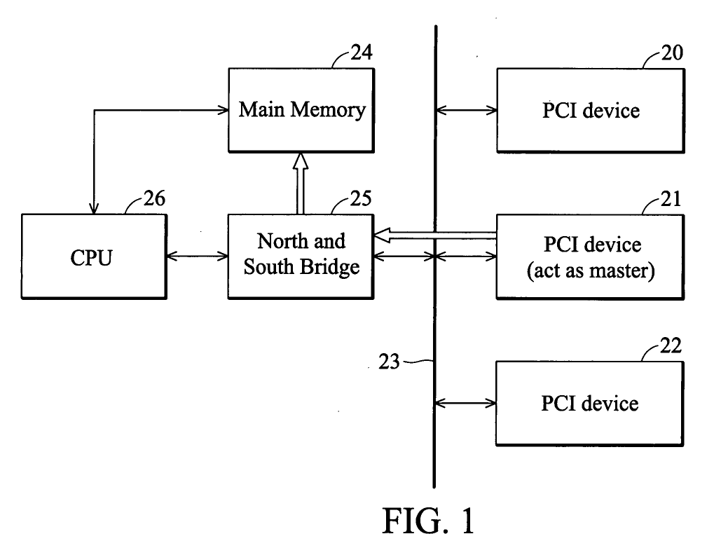

FIG. 2 is a schematic of a PCI DMA architecture according to the related art; and

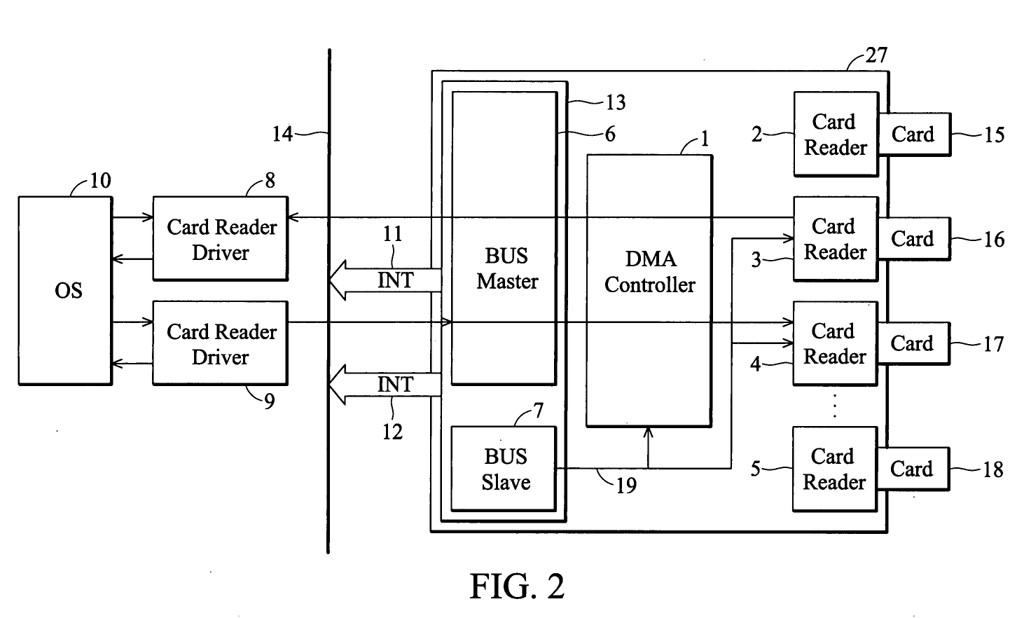

FIG. 3 is a schematic of a hidden DMA architecture according to the present invention.

### DETAILED DESCRIPTION

A detailed description of the present invention is provided in the following.

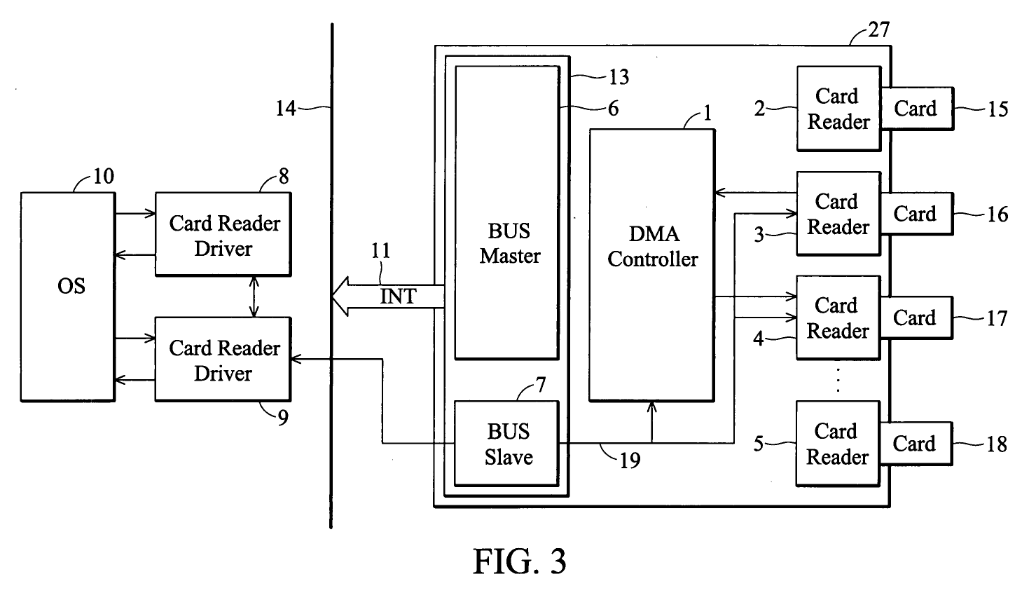

As shown in FIG. 3, a multi-card reader 27 is inserted into a system bus 14 of the computer system and controlled by commands delivered through card readers 8 and 9 from the operating system 10. The multi-card reader 27 comprises a bus controller 113, DMA controller 1, and card readers 2˜5 disposed therein. The bus controller 13 is a combination of bus master 6 and bus slave 7. The bus master 6 directs the system bus 14 during data transfer and the bus slave 7 receives commands delivered through the system bus 14 from the operating system 10, and responds to the operating system 10 with flags having a value.

The DMA controller 1 directs the entire data flow of multi-card reader 27, and is capable of copying data between any of the devices under instructions of the driver 19, for example, from card reader to card reader, from card reader to system, or from system to card reader.

Memory cards 15˜18 are inserted in corresponding card readers 2˜5, specifications of which include Memory-Stick (MS), Safe-Digital(SD), Smart-Media(SM) and xD-Picture(XD). The system bus 14 conforms to Peripheral Connection Interface (PCI), Industrial Standard Architecture (ISA), or Low Pin Count (LPC), standards.

In FIG. 3 illustrates a situation wherein data is copied from memory card 16 to memory card 17, a multi-card reader 27 comprising a bus controller 13 coupled with the system bus 14, under direction of the operating system 10 in cooperation with card-reader driver 8 or 9. The card reader 3 reads the card driver 8, and the card reader 4 reads the card driver 9. A copy command is delivered from the card-reader driver 8 under instructions of the operating system 10, via the system bus 14, and received by a bus slave 7 located inside the bus controller 13, to initialize the DMA controller 1, card reader 3 and card reader 4.

After initialization is complete, the data is read by the DMA controller from the card reader 3, and an interrupt request is simultaneously sent to the operating system 10 through the bus master 6 located inside the bus controller 13, notifying the system that the copying process has been initiated. The card-reader driver 9 is then instructed by the operating system 10 to monitor the value of a flag inside the DMA controller 1.

Data is written by the DMA controller to the memory card 17 through the card reader 4. When complete, the flag is set to a pre-determined value for notifying the operating system 10 that the copying process is complete.

In another embodiment, an interconnect mechanism is implemented on card-reader drivers 8 and 9 to automate the initialization of the corresponding card readers without occupying the operating system 10. The operating system 10 is only required to deliver an instruction, and the card-reader drivers complete the remaining tasks freeing the operating system 10 from the burden of completing initializing steps for each of the involved components.

Thus by means of the method of hidden DMA transfer according to the present invention, data is directly transferred between memory cards through an internal DMA (Direct Memory Access) controller, without accessing the main memory or occupying the PCI bus. Only an acknowledgement is expected by the central processing unit, to indicate the completion of the copying process.

Thus the data transfer occupies the following components in order. Memory card 16, card reader 3, DMA controller 1, card reader 4, memory card 17, for a total of 5 steps, and the system were interrupted only once. Compared to the 13 steps and two interrupts of the conventional method, the present invention is more efficient, faster and reduces system resource consumption.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A card reading apparatus, for copying data from a first memory card to a second memory card, comprising:
a multi-card interface, for connecting with the first memory card and the second memory card to access data stored therein;
a bus controller, connected to a system bus, for receiving a copy command sent from a system through the system bus; and
a DIRECT-MEMORY-ACCESS controller, for directly copying data from the first memory card to the second memory card without occupying the system bus when the copy command sent from the system is received through the bus controller.

2. The apparatus as claimed in claim 1, wherein the specification of the system bus is either Peripheral Component Interconnect or Industry Standard Architecture.

3. The apparatus as claimed in claim 1, wherein the specification of the first memory card and the second memory card is Memory Stick, Safe Digital, Smart Media or XD-pictures.

4. The apparatus as claimed in claim 1, wherein the bus controller further comprises a bus master, for sending a bus controlling request to the system, and communicating with a device on the system bus or within the system, through the system bus.

5. The apparatus as claimed in claim 1, wherein the bus controller further comprises a bus slave, for receiving the copy command through the system bus, and sending a flag from the DIRECT-MEMORY-ACCESS controller to the system.

6. A method of copying data between multiple memory cards, comprising the following steps:
receiving a copy command sent from a system through a system bus;
reading data from a first memory card through a first card reader after receiving the copy command; and
writing data to a second memory card through a second card reader directly without occupying the system bus.

7. The method as claimed in claim 6, further comprising a step of initializing the DIRECT-MEMORY-ACCESS controller, the first card reader and the second card reader after receiving the copy command.

8. The method as claimed in claim 6, further comprising a step of sending an interrupt to the system through a bus master within a bus controller after receiving the copy command, for informing the system that the copy command is executed.

9. The method as claimed in claim 6, further comprising a step of setting a flag within the DIRECT-MEMORY-ACCESS controller to a pre-determined value after writing data to the second memory card.

10. A method of copying data between multiple memory cards, comprising the following steps:
receiving a copy command sent from a system through a system bus;
initializing the DIRECT-MEMORY-ACCESS controller, the first card reader and the second card reader after receiving the copy command;
sending an interrupt to the system through a bus master within a bus controller after receiving the copy command, for informing the system that the copy command is executed;
reading data from a first memory card through a first card reader after receiving the copy command;
writing data to a second memory card through a second card reader directly without occupying the system bus; and
setting a flag within the DIRECT-MEMORY-ACCESS controller to a pre-determined value after writing data to the second memory card.
